(19) United States
(12) Patent Application Publication
(10) Pub. No.: US 2012/0118992 A1
(43) Pub. Date: May 17, 2012

(54) FLUID SHAPING APPARATUS

(76) Inventor: Nathan Pratt, Oklahoma City, OK (US)

(21) Appl. No.: 13/296,215

(22) Filed: Nov. 14, 2011

Related U.S. Application Data
(60) Provisional application No. 61/413,424, filed on Nov. 13, 2010.

(51) Int. Cl. B05B 1/30

(52) U.S. Cl. 239/1; 239/589

(57) ABSTRACT

A fluid shaping apparatus includes a nozzle and one or more armature bars. The nozzle includes a first end and a second end and has an inlet port positioned at the first end of the nozzle and an outlet port positioned at the second end of the nozzle. The nozzle also includes one or more armature bar guides that are used to retain the armature bars. During use, the nozzle accepts a water flow through the inlet port and delivers that water flow through the outlet port. In the preferred embodiment, the water flow is directed through the outlet port to a deflection plate. The shape of the water flow is then formed and extended by constraining the edges of its shape with the plurality of armature bars, which are connected to the nozzle via a plurality of armature bar attachment guides.

### RELATED APPLICATIONS

The present application claims the benefit of U.S. Provisional Patent Application No. 61/413,424, entitled Fluid Shaping Apparatus, filed Nov. 13, 2011, the disclosure of which is incorporated herein.

### FIELD OF THE INVENTION

The present invention is generally related to the field of water spraying systems and water sculpture.

### BACKGROUND OF THE INVENTION

For many years, artists have chosen to explore the use of different media as material for their sculptures. Traditional media for sculpting includes clay, textiles, plastics, polymers and softer metals. Various stones such as marble or granite are also commonly used in sculptures.

Fountains are one type of sculpture that utilize such common media (often stone and soft metals) as the basis for the sculpture, but integrate water as an additional medium. Modern fountains manipulate streams of water into arcs and curves that often complement, and in some cases replace, the forms crafted with more traditional media. While artists are able to create simple arcs and fans of water using present fountain technology, such shapes are limited by current nozzle technology, as once the water leaves the fountain's nozzle, the artist has no control over the shape of the water stream.

Thus, a need exists for a technique that permits an artist to design a sculpture using a water medium while allowing for shape control without requiring the need of an underlying traditional-media sculpture.

### SUMMARY OF THE INVENTION

In a presently preferred embodiment, the invention includes a method and apparatus for projecting an initial shape of a stream of water, and then conforming that shape without the use of underlying traditional media sculpture. In preferred embodiments, the fluid shaping apparatus includes a nozzle and one or more armature bars. The nozzle includes a first end and a second end and has an inlet port positioned at the first end of the nozzle and an outlet port positioned at the second end of the nozzle. The nozzle also includes one or more armature bar guides that are used to retain the armature bars.

During use, the nozzle accepts a water flow through the inlet port and delivers that water flow through the outlet port. In the preferred embodiment, the water flow is directed through the outlet port to a deflection plate. The deflection plate imparts the initial shape to the water flow. In preferred embodiments, the deflection plate is used to flatten, diffuse or scatter the water flow. The shape of the water flow is then formed and extended by constraining the edges of its shape with the plurality of armature bars, which are connected to the nozzle via a plurality of armature bar attachment guides.

### BRIEF DESCRIPTION OF THE DRAWINGS

FIG. 1-A is a front perspective view of a nozzle constructed in accordance with a first preferred embodiment.

FIG. 1-B is a side view of the nozzle of FIG. 1-A.

FIG. 2 is a perspective view of a nozzle constructed in accordance with a second preferred embodiment.

FIG. 3-A is a perspective view of a nozzle constructed in accordance with a third preferred embodiment.

FIG. 3-B is a front view of the nozzle of FIG. 3-A.

FIG. 4 is a perspective view of a nozzle constructed in accordance with a fourth preferred embodiment.

FIG. 5 is a perspective view of a nozzle constructed in accordance with a fifth preferred embodiment.

FIG. 6-A is a perspective view of a nozzle constructed in accordance with a sixth preferred embodiment.

FIG. 6-B is a side view of the preferred embodiment as depicted in FIG. 6-A.

FIG. 7 is a perspective view of a nozzle constructed in accordance with a seventh preferred embodiment.

FIG. 8-A is a front view of a nozzle constructed in accordance with an eighth preferred embodiment.

FIG. 8-B is a cross-sectional perspective view of preferred embodiment as depicted in FIG. 8-A.

FIG. 9-A is a front view of a nozzle constructed in accordance with a ninth preferred embodiment.

FIG. 9-B is a cross-sectional perspective view of preferred embodiment as depicted in FIG. 9-A.

FIG. 10-A is a front view of a nozzle constructed in accordance with a tenth preferred embodiment.

FIG. 10-B is a cross-sectional perspective view of preferred embodiment as depicted in FIG. 10-A.

FIG. 10-C is a top view of nozzle depicted in FIG. 10-A and FIG. 10-B.

FIG. 11-A is a side view of an eleventh preferred embodiment.

FIG. 11-B is a front view of a nozzle constructed in accordance with an eleventh preferred embodiment.

FIG. 11-C is a cross-sectional perspective view of preferred embodiment as depicted in FIG. 11-B.

FIG. 12-A is a side view of a twelfth preferred embodiment.

FIG. 12-B is a front view of the preferred embodiment in FIG. 12-A.

FIG. 12-C is a cross-sectional perspective view of the preferred embodiment as depicted in FIG. 12-A.

FIG. 12-D is a top view of preferred embodiment as depicted in FIG. 12-A.

FIG. 13-A is a front view of a thirteenth preferred embodiment.

FIG. 13-B is a side view of the preferred embodiment depicted in FIG. 13-A.

FIG. 13-C is a cross-sectional perspective view of preferred embodiment depicted in FIG. 13-A.

FIG. 14 is a cross-sectional perspective view of a nozzle constructed in accordance with a fourteenth preferred embodiment.

FIG. 15 is a perspective view of a nozzle constructed in accordance with a fifteenth preferred embodiment.

FIG. 16-A is a side view of a nozzle constructed in accordance with a sixteenth preferred embodiment.

FIG. 16-B is a front view of preferred embodiment as depicted in FIG. 16-A.

FIG. 16-C is a cross-sectional perspective view of preferred embodiment as depicted in FIG. 16-A.

FIG. 17 is a top view of a nozzle constructed in accordance with a seventeenth preferred embodiment.

FIG. 18-A is a front view of a nozzle constructed in accordance with an eighteenth preferred embodiment.

FIG. 18-B is a cross-sectional perspective view of preferred embodiment as depicted in FIG. 18-A.

FIG. 19-A is a front view of a nozzle constructed in accordance with a nineteenth preferred embodiment.

FIG. 19-B is a cross-sectional perspective view of preferred embodiment as depicted in FIG. 19-A.

FIG. 20-A is a front view of a nozzle constructed in accordance with a twentieth preferred embodiment.

FIG. 20-B is a side view of preferred embodiment as depicted in FIG. 20-A.

FIG. 20-C is a cross-sectional perspective view of preferred embodiment as depicted in FIG. 20-A.

FIG. 21-A is a cross-sectional perspective view of a nozzle constructed in accordance with a twenty-first preferred embodiment.

FIG. 21-B is a bottom view of preferred embodiment as depicted in FIG. 21-A.

FIG. 22-A is a front view of a nozzle constructed in accordance with a twenty-second preferred embodiment.

FIG. 22-B is a cross-sectional perspective view of preferred embodiment as depicted in FIG. 22-A.

### DETAILED DESCRIPTION OF PREFERRED EMBODIMENTS

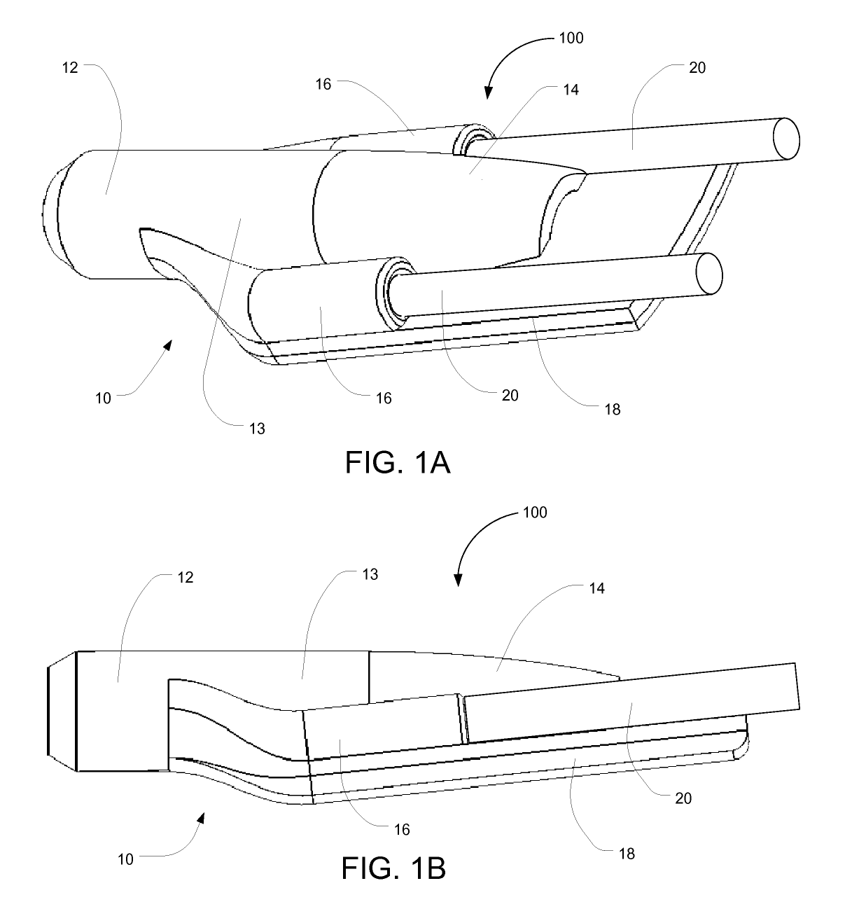

Referring first to FIGS. 1-A and 1-B, in accordance with a first preferred embodiment, a fluid shaping apparatus 100 includes a nozzle 10 and a plurality of armature bars 20. The nozzle 10 generally includes an inlet port 12, a nozzle body 13, an outlet port 14, a plurality of armature bar guides 16, and at least one deflection plate 18. The armature bars 20 are connected to the nozzle 10 via the armature bar guides 16.

As depicted in FIG. 1, the inlet port 12 is designed to accept a flow of water from a connected conduit (not shown). It will be understood by those skilled in the art that the inlet port 12 may be connected in a variety of ways to the conduit. In one preferred embodiment, the inlet port 12 is threaded and configured to connect with a standard garden hose. In another preferred embodiment, the inlet port 12 is configured to be press-fitted to ⅛″ copper tubing. In yet another preferred embodiment, the inlet port 12 is configured with one of several known “quick-release” mechanisms well known in the art, so that the inlet port 12 can be quickly connected (or disconnected) from the upstream conduit. In each embodiment, however, the inlet port 12 is designed so that it can accept a water flow from a water source through a conduit.

The inlet port 12 is in turn connected to the outlet port 14 of the nozzle 10. The connection between the inlet port 12 and outlet port 14 is designed so that the water flow may be delivered from the water source to the outlet port 14. In the preferred embodiment shown in FIGS. 1-A and 1-B, the outlet port 14 is tapered opposite its connection with the inlet port 12 so that the velocity of the water increases as the water exits the outlet port 14. The precise shape and degree of tapering may be configured based upon the characteristics of the water flow and the specific requirement of the application.

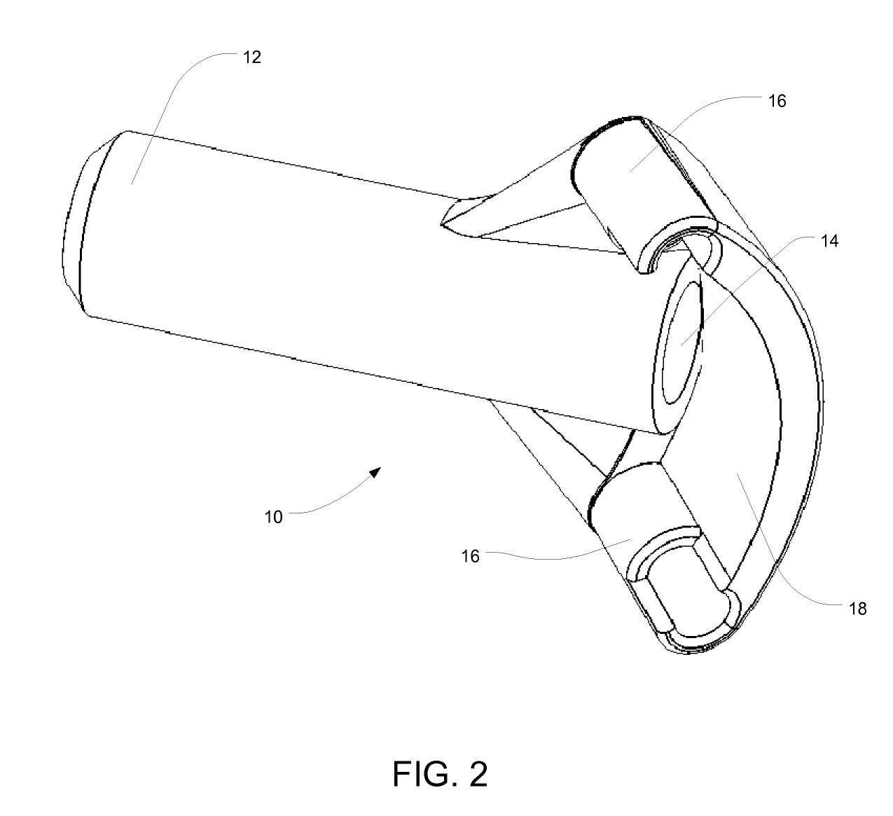

The outlet port 14 is configured so that the exiting water flow is directed at the deflection plate 18. As the water flow exits the outlet port 14 and strikes the deflection plate 18, it is directed along the surface of the deflection plate 18. This directing action changes the shape for the water flow from a general stream-shape to a shape more sheet-like in nature. That sheet-like shape can be adjusted by configuring the angle at which the water flow initially strikes the deflection plate 18, the shape of the deflection plate 18 and the distance between the outlet port 14 and the deflection plate 18. As can be seen in FIG. 1-A, a preferred embodiment of the deflection plate 18 is a slightly concave surface. In the second preferred embodiment depicted in FIG. 2, the curvature of the deflection plate 18 is more pronounced. By using a curved deflection plate 18 in the nozzle 10, the user is able to impart a curve to the sheet-like shape of water. In the currently preferred embodiments, the deflection plate 18 is permanently connected to the nozzle body 13, but it will be understood that the deflection plate 18 could be removably connected to the nozzle body 13 so that deflection plates 18 of different configurations can be interchangeably used.

Continuing with FIGS. 1-A and 1-B, it will be noted that the connection point of the deflection plate 18 and the outlet port 14 form a notch 22 through which the water flow may exit. The notch 22 is principally important to improving the shaping characteristics of the deflection plate 18 by permitting the water flow to begin its dispersion from the outlet port 14 and adherence to the deflection plate 18. Also shown in FIGS. 1-A and 1-B are the armature bars 20 connected to the nozzle 10 via the armature bar guides 16. In the preferred embodiment, the armature bars 20 are inserted into the armature bar guides 16 and are secured via a simple flush fitting. In an alternative embodiment, the armature bars 20 are threadably engaged within the armature bar guides 16. As the water exits the outlet port 14 and strikes the deflection plate 18, the water flow shape is changed from a stream to a sheet. Through surface tension, the sheet of water is maintained through contact with the armature bars 20. In a presently preferred embodiment, the armature bars 20 are configured as copper tubing or metal wire. Alternatively, however, it may be desirable to configure the armature bars 20 using flexible conduit, chain or cables. The armature bars 20 permit the creation of panes of water by adding form to the stream of water exiting the nozzle 10. By adjusting the angular disposition of the armature bars 20, the shape of the sheets of water can be manipulated.

In addition to the fundamental principles of the preferred embodiments depicted in FIGS. 1-A and 1-B, reference is now made to the plurality of alternative preferred embodiments of the fluid shaping apparatus 100. Unless otherwise noted, the alternative preferred embodiments include the same components described above with reference to FIGS. 1-A and 1-B. For clarity, the armature bars 20 have been removed from the balance of the drawings.

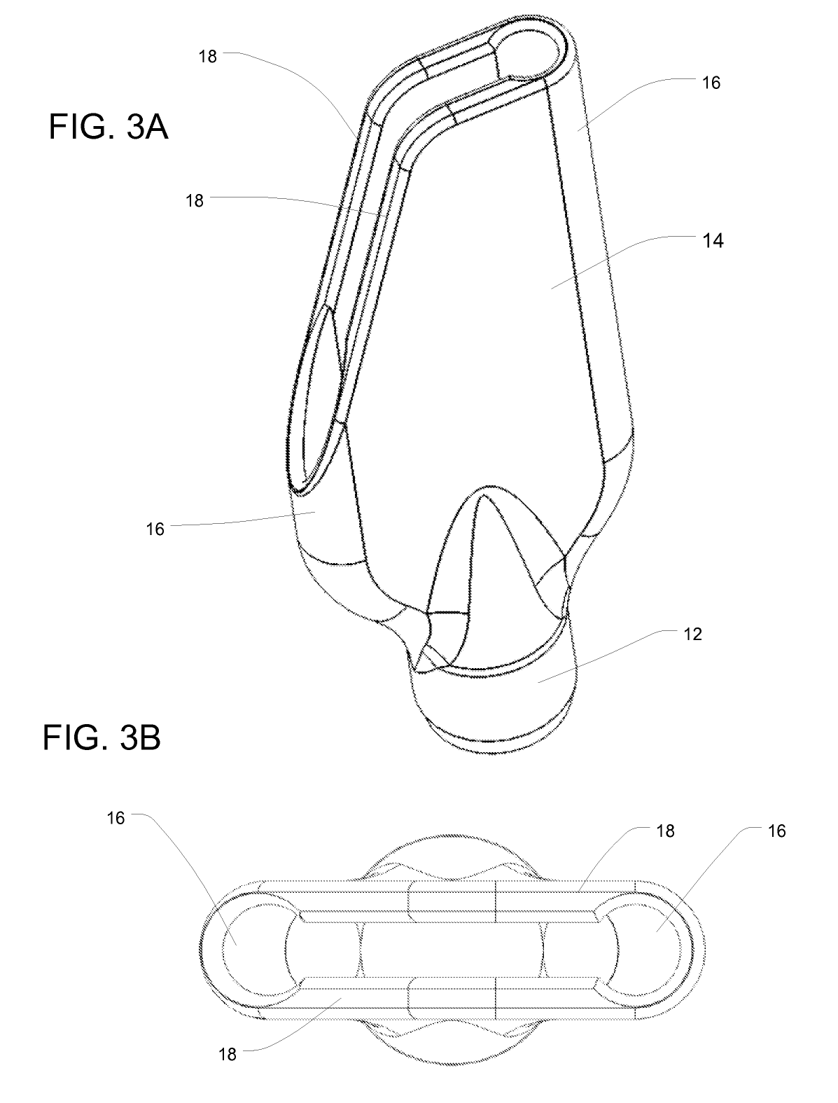

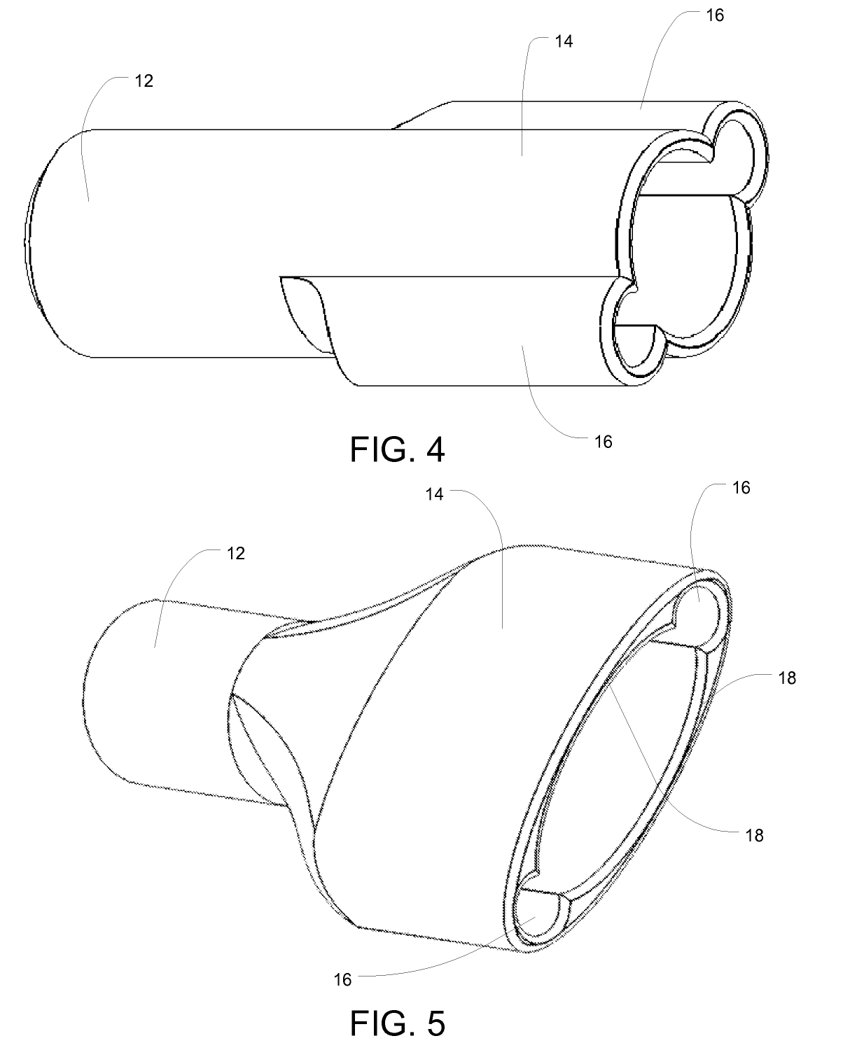

Turning to FIG. 2, shown therein is a nozzle 10 that includes a concave deflection plate 18 that is positioned relative the outlet port 14 at a substantially right angle. In contrast, the nozzle 10 of FIGS. 3-A and 3-B includes a pair of flat deflection plates that encase both sides of the outlet port 14. The chamfered shape of the deflection plates 18 encourages the dispersal of the water stream towards the shorter armature bar guide 16. The embodiment depicted in FIG. 4 does not include a deflection plate and the outlet port 14 and armature bar guides 16 are aligned in parallel. Similarly, the nozzle depicted in FIG. 5 includes a large outlet port 14 with a small, ring-shaped deflection plate 18.

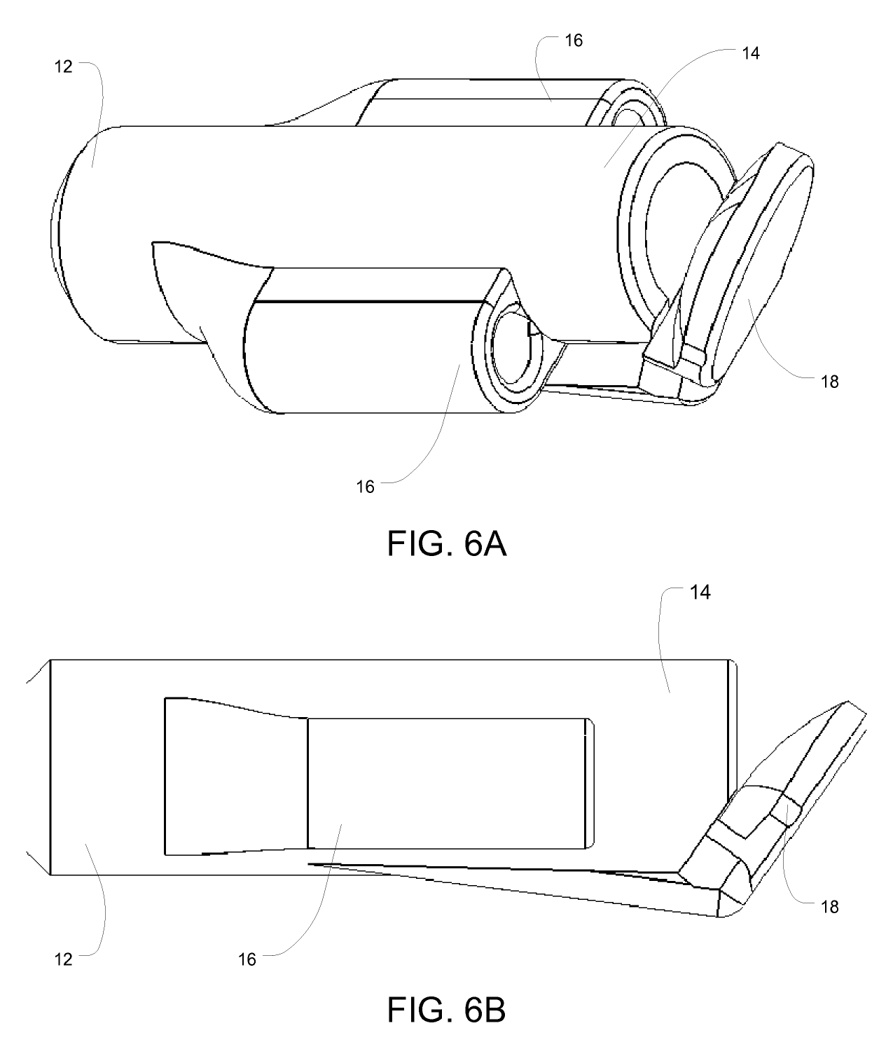

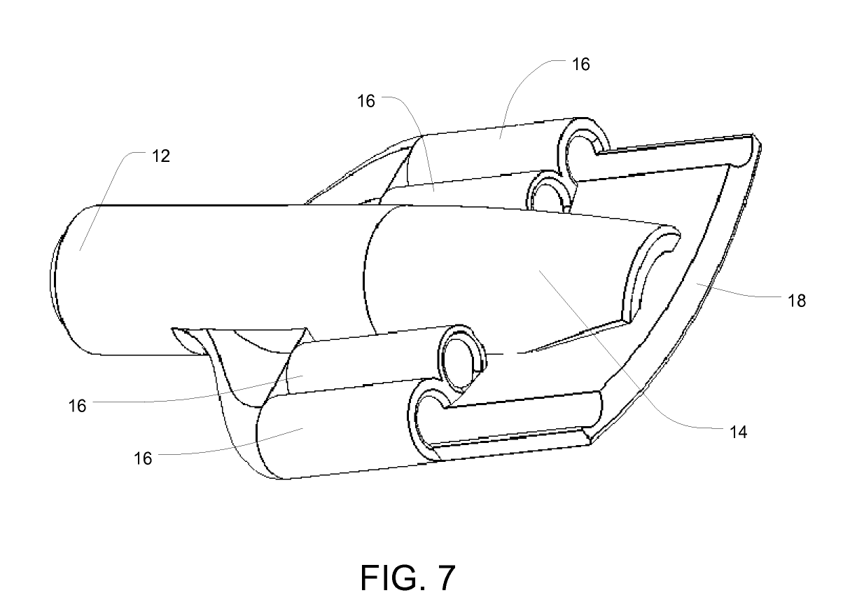

Turning to FIGS. 6-A and 6-B, shown therein are perspective and side views, respectively, of a nozzle 10 that includes a deflection plate 18 positioned at an acute angle to the outlet port 14. The deflection plate 18 includes a convex contact surface. The combination of the convex contact surface and the aggressive angular disposition of the deflection plate create a fanned water sheet that is bounded by the armature bars 20 (not shown). The embodiment depicted in FIG. 7 includes four armature bar guides 16 and a large, concave deflection plate. The use of four armature bars 20 permits the production of secondary water panes in planes geometrically askew to the primary pane. It will be understood that the relative positioning of the deflection plates 18, the outlet port 14 and the armature attachment guides 16 can vary greatly to accomplish the goals of the invention. As noted above with reference to FIG. 4, it may not be necessary or desirable to employ the deflection plate 18.

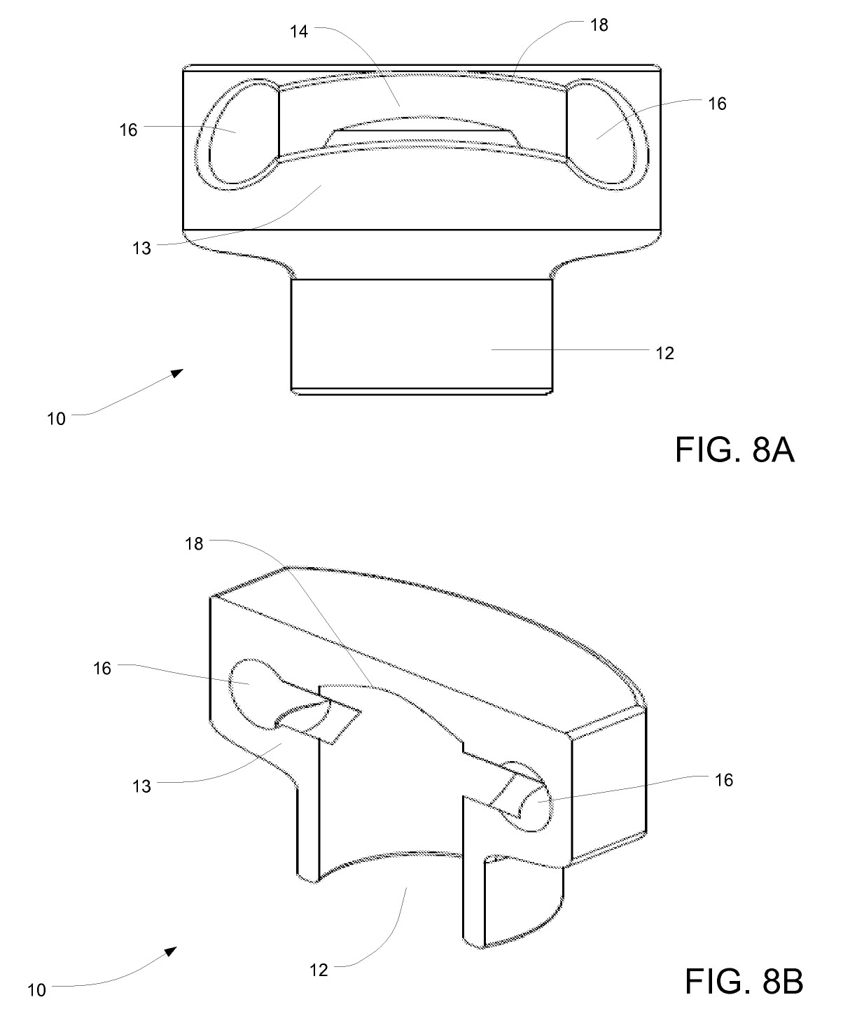

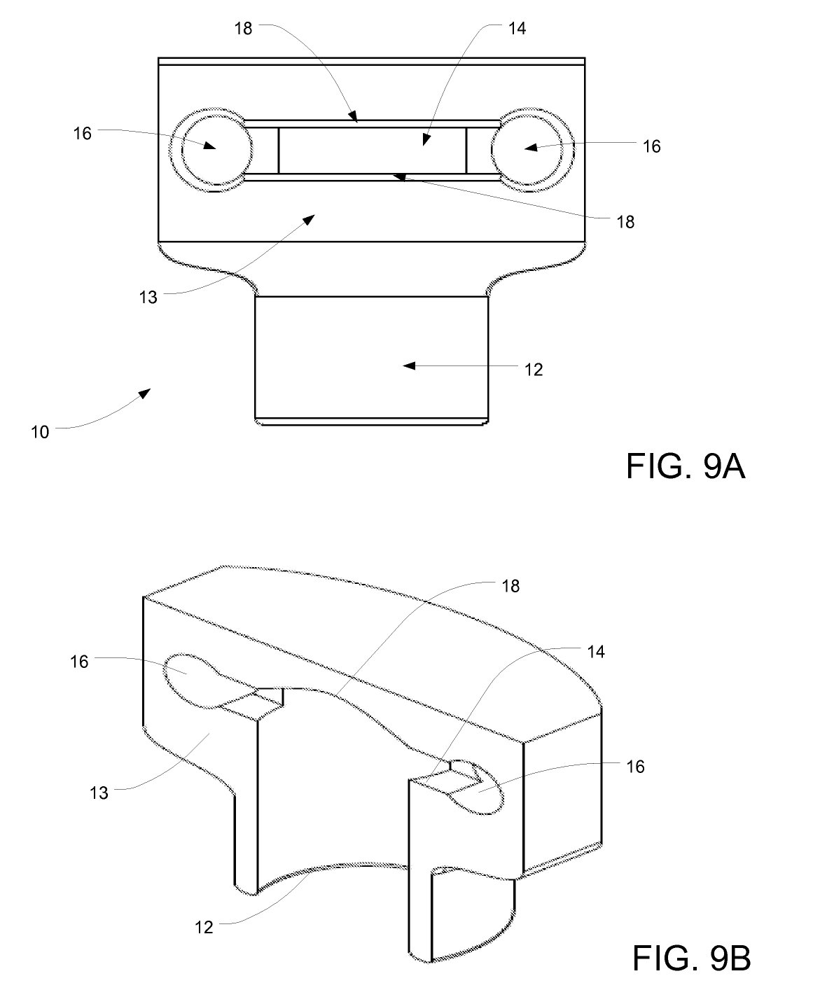

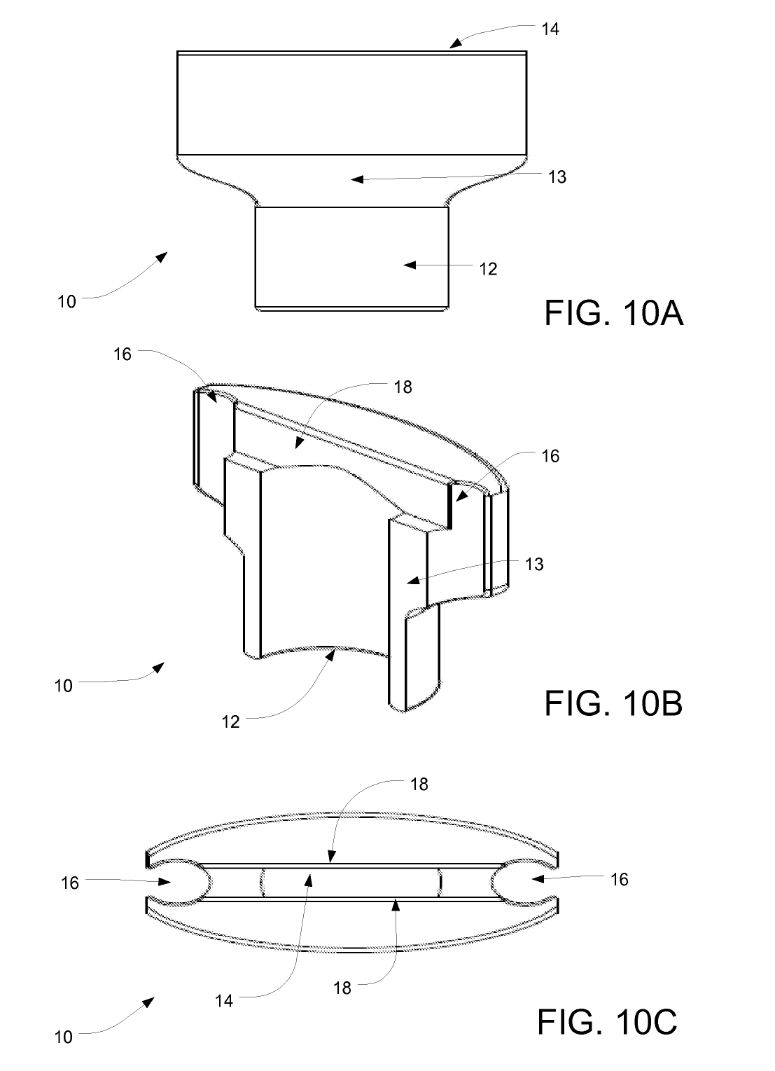

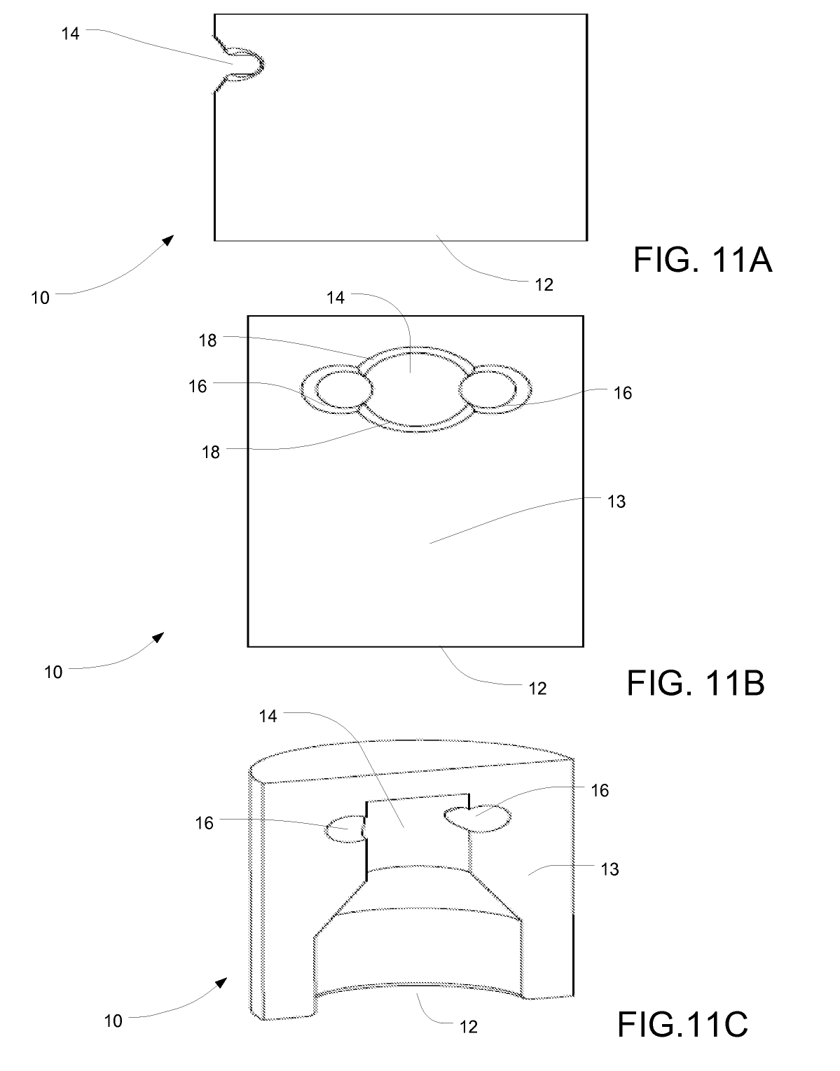

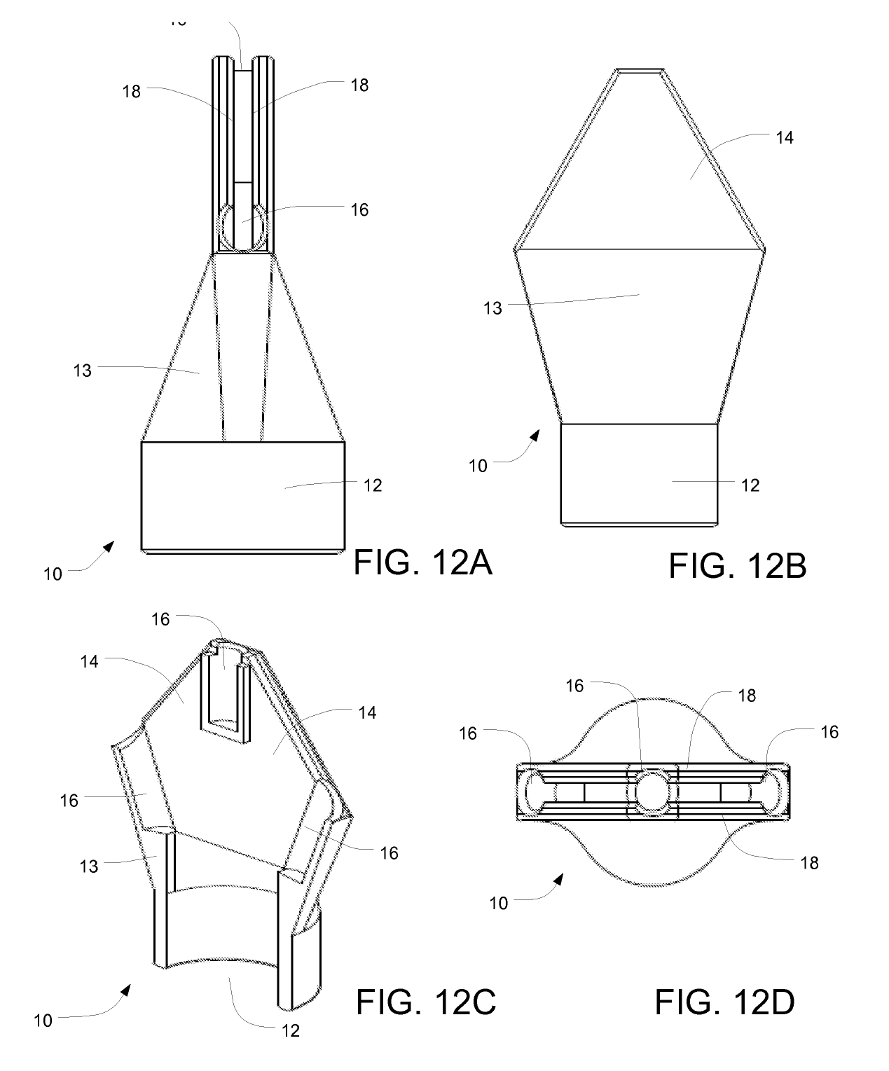

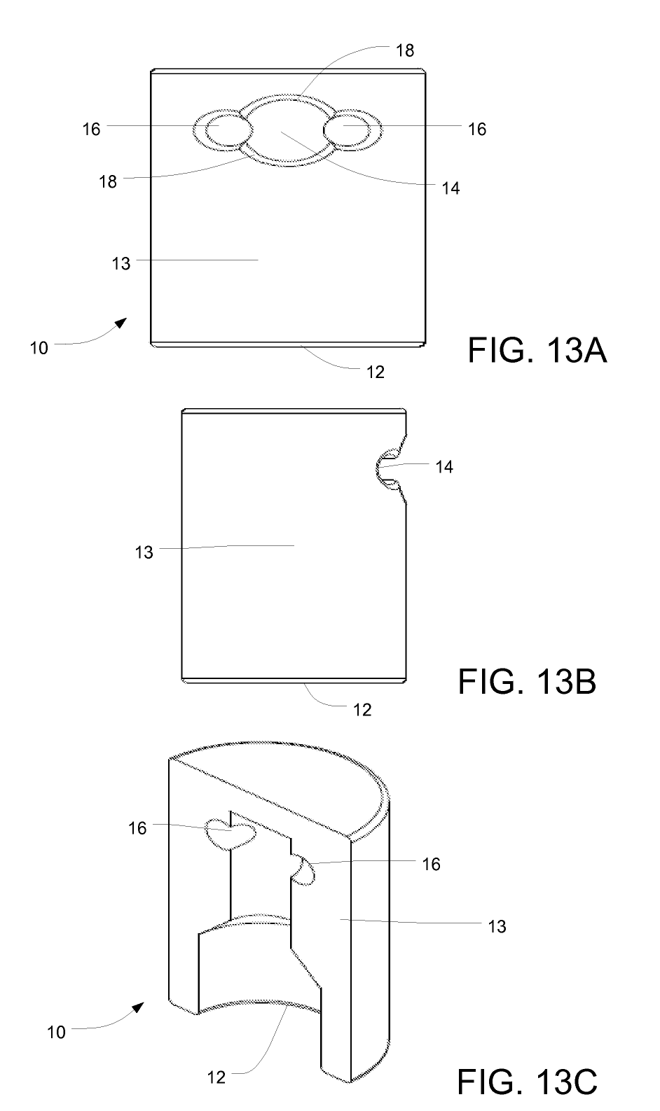

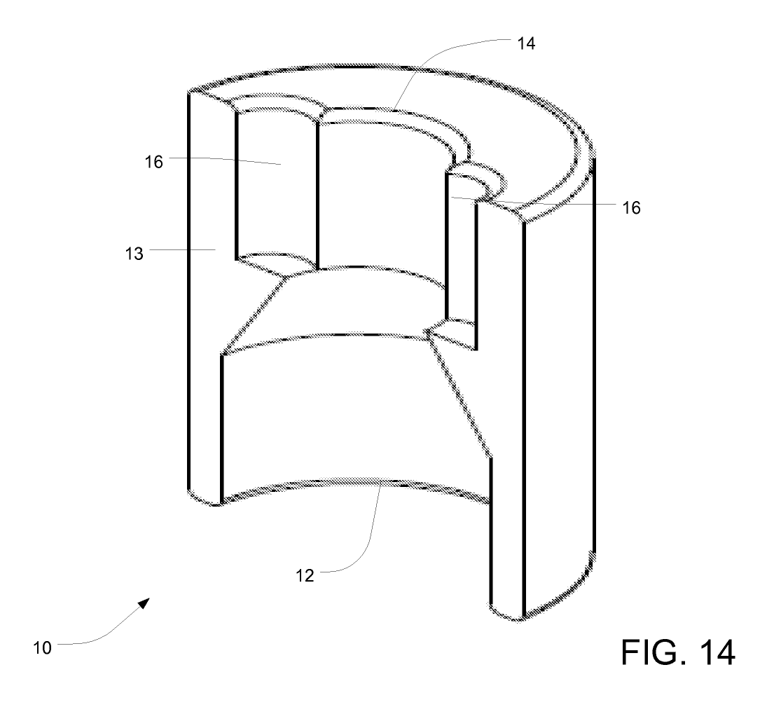

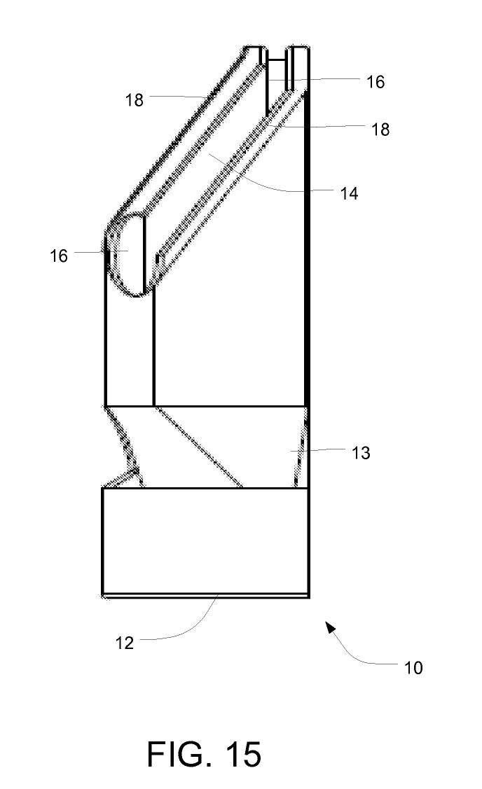

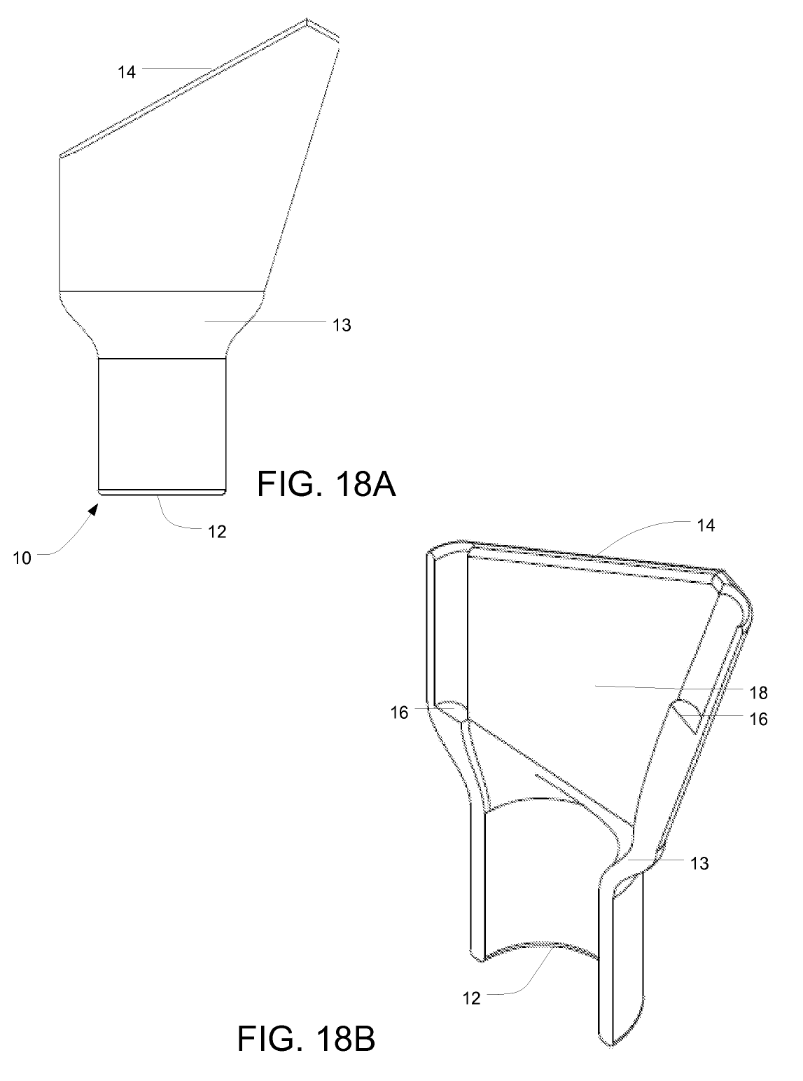

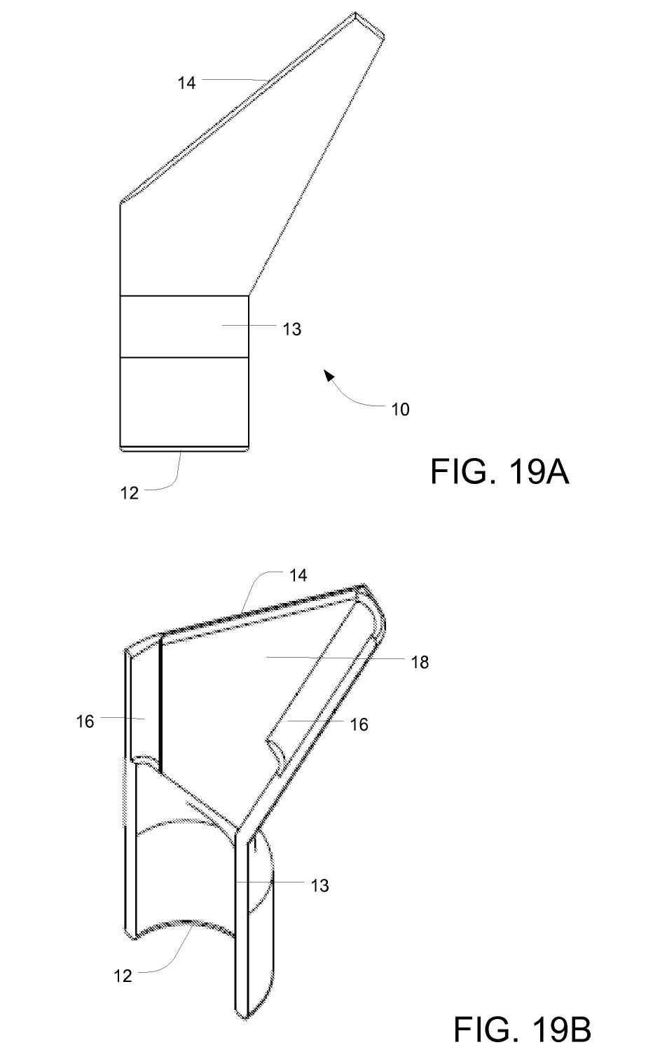

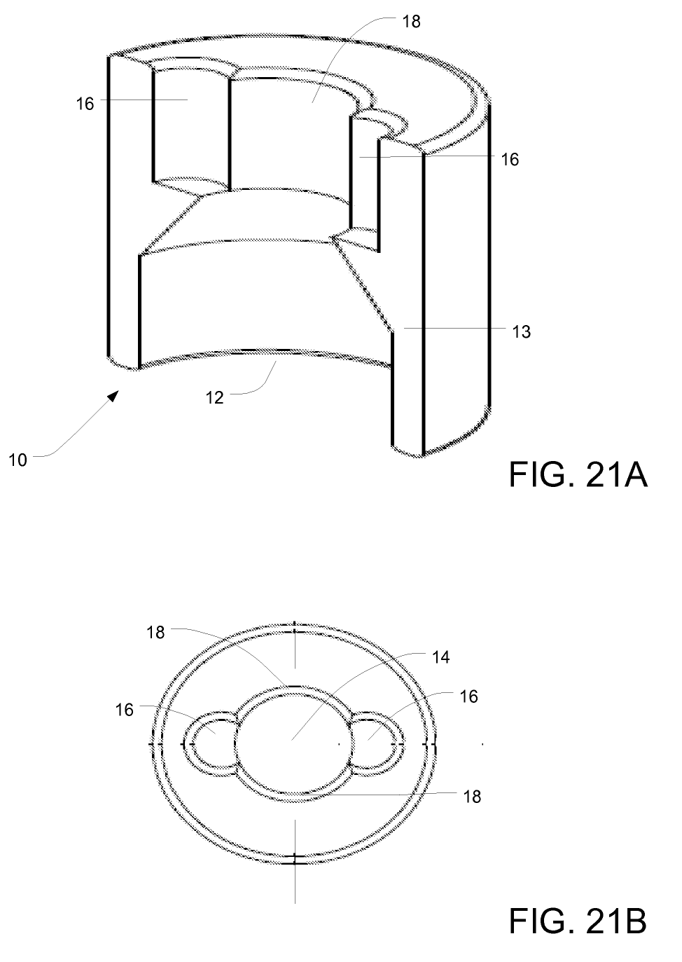

FIGS. 8A-22B identify several alternative preferred embodiments. For example, in the fourteenth preferred embodiment depicted in FIG. 14, the deflection plate 18 is not used and the oval shape of the outlet port 14 conforms the shape of the exiting water stream. In certain embodiments, the outlet port 14 is oriented at an angle to the inlet port 12. In the embodiments depicted in FIGS. 9A and 9B, the outlet port 14 is disposed at a right angle to the inlet port 12. Similarly, in the embodiments depicted in FIGS. 11A-11C, the outlet port 14 is oriented at a right angle with the inlet port 12 and the nozzle 10 does not include a deflection plate 18. Turning to FIGS. 12A-12D, the twelfth preferred embodiment of the fluid shaping apparatus 100 includes three armature bar guides 16 that in cooperation with two parallel deflection plates 18 form twin outlets 14. The fluid shaping apparatus of FIGS. 12A-12D form a pair of water panes connected by the central armature bar 20.

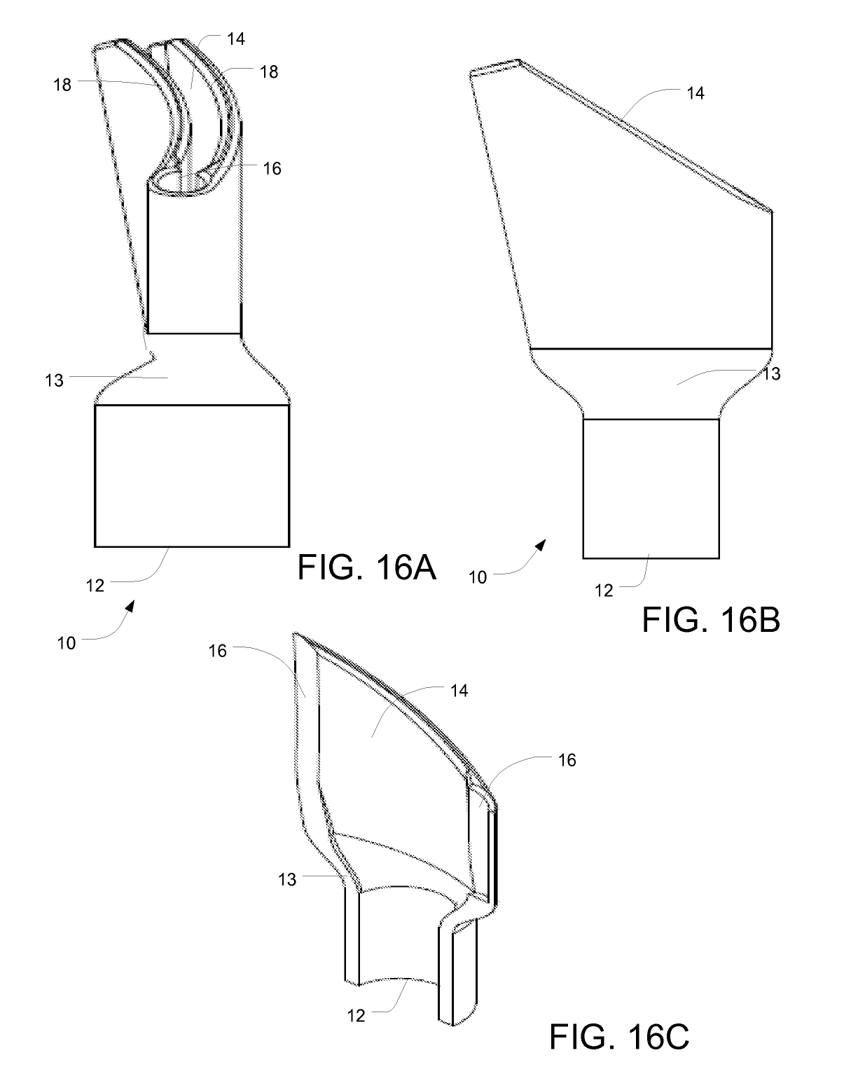

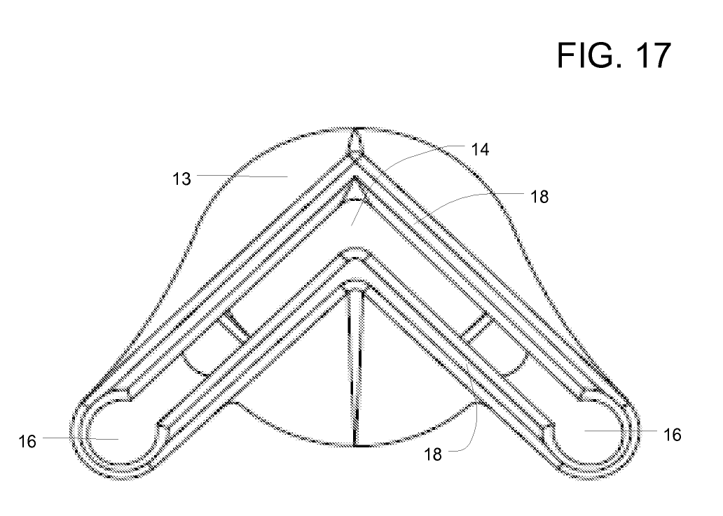

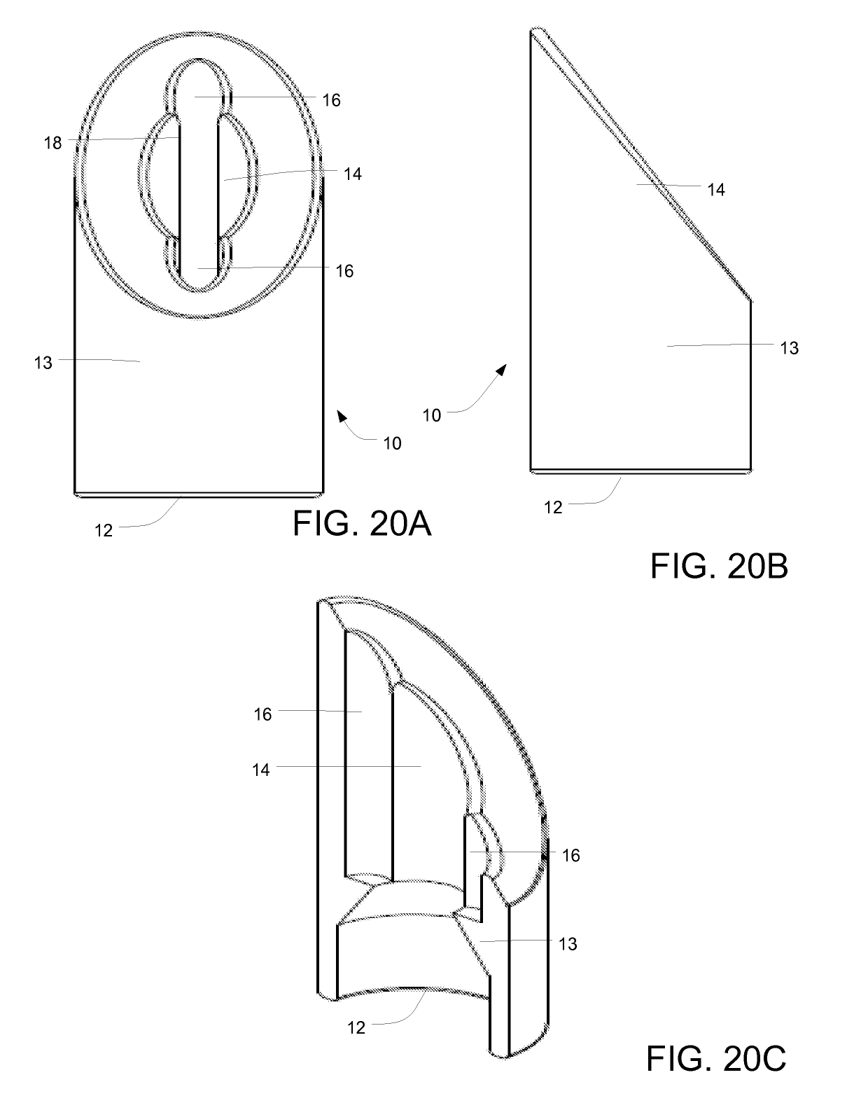

The fluid shaping apparatus depicted in the sixteenth preferred embodiment depicted in FIGS. 16A-16C includes curved deflection plates 18 that cooperate with a pair of armature bar guides 16 to form a curved form of water. The angularly-disposed deflection plates 18 of the seventeenth embodiment in FIG. 17 forms a pair of water panes bounded by the outside armature bars 20. In the twentieth embodiment depicted in FIGS. 20A-20C, the armature bar guides 16 are placed in open fluid communication with the nozzle outlet 14 within the body 13 of the nozzle 10.

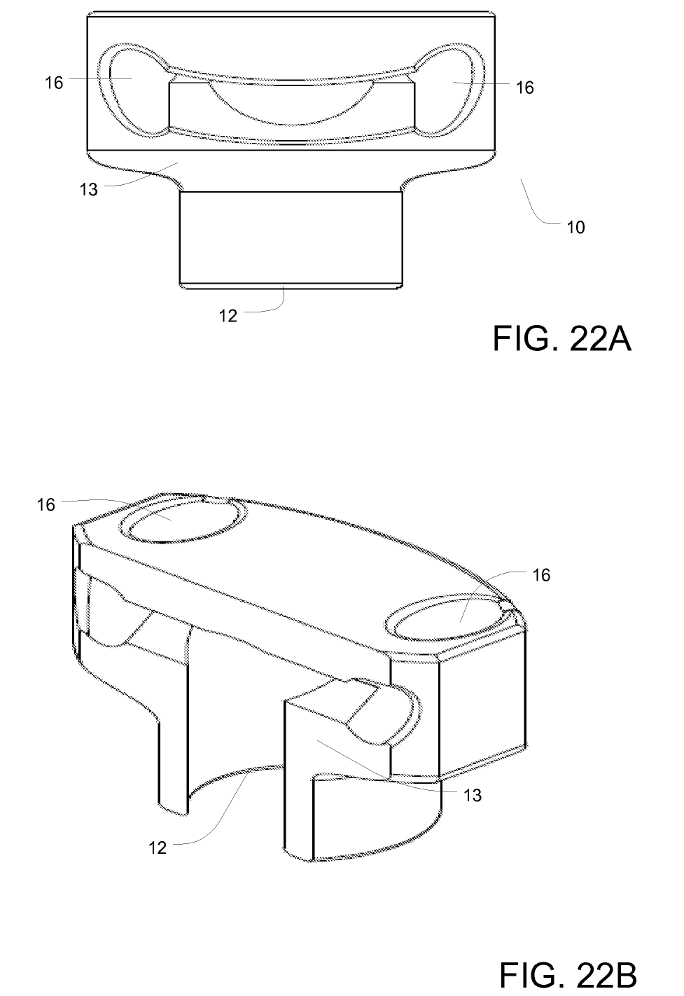

In the twenty-second embodiment depicted in FIGS. 22A-22B, the armature bar guides 16 extend out the face of the nozzle 10 and also through the top of the nozzle 10. In this way, additional nozzles can be stacked onto the armature bars 20 that extend from the nozzle 10. It will be appreciated that the stacking of additional nozzles 10 can be used to extend and modify the formation of adjacent water panes and forms.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms expressed in the appended claims.

It is claimed:

1. A fluid shaping apparatus comprising:
a nozzle having a first end and a second end, the nozzle further comprising:
an inlet port positioned at the first end of the nozzle;
an outlet port positioned at the second end of the nozzle;
one or more armature bar guides; and
one or more armature bars, wherein each of the one or more armature bars is positioned within a corresponding armature bar guide.

2. The fluid shaping apparatus of claim 1, further comprising a plurality of armature bar guides and a plurality of armature bars, wherein each of the plurality of armature bars extends from a corresponding one of the plurality of armature bar guides.

3. The fluid shaping apparatus of claim 2, wherein the nozzle further comprises at least one deflection plate disposed in proximity to the outlet port.

4. The fluid shaping apparatus of claim 3, wherein the nozzle further comprises a plurality of deflection plates disposed in proximity to the outlet port.

5. The fluid shaping apparatus of claim 4, wherein the nozzle comprises two deflection plates disposed in a substantially parallel relationship to one another.

6. The fluid shaping apparatus of claim 4, wherein the nozzle comprises two deflection plates disposed in a positional relationship to each other at an acute angle.

7. The fluid shaping apparatus of claim 4, wherein the nozzle comprises two deflection plates disposed in a positional relationship to each other at an obtuse angle.

8. The fluid shaping apparatus of claim 4, wherein the nozzle comprises two deflection plates disposed in a positional relationship perpendicular to each other.

9. The fluid shaping apparatus of claim 1, wherein the outlet port is linearly aligned with the inlet port.

10. The fluid shaping apparatus of claim 1, wherein the outlet port is perpendicularly aligned with the inlet port.

11. The fluid shaping apparatus of claim 1, wherein the outlet port is positioned at an acute angle to the inlet port.

12. The fluid shaping apparatus of claim 1, wherein the outlet port is position at an obtuse angle to the inlet port.

13. A fluid shaping apparatus, the apparatus comprising:
a first nozzle, wherein the first nozzle includes:
a pair of armature bar guides;
an inlet port;
an outlet port between the pair of armature bar guides;
one or more deflection plates positioned between the pair of armature bar guides; and
a plurality of armature bars, wherein a pair of the plurality of armature bars are retained by a corresponding one of the pair of armature bar guides.

14. The fluid shaping apparatus of claim 13, further comprising a second nozzle, wherein the second nozzle is connected to the plurality of armature bars.

15. A method for shaping a stream of fluid with a fluid shaping apparatus, the method comprising:
accepting the stream into an inlet port of the fluid shaping apparatus;
channeling the stream to an outlet port;
diffusing the stream with a plurality of deflection plates; and
shaping the stream by spanning it between a plurality of armature bars as it exits the outlet port and deflection plates.
